(19) United States
(12) Patent Application Publication
(10) Pub. No.: US 2018/0237034 A1
(43) Pub. Date: Aug. 23, 2018

(54) CONVEYANCE SYSTEM

(71) Applicants: TSUBAKIMOTO CHAIN CO., Osaka (JP); TOAN CO., LTD., Tokyo (JP)

(72) Inventors: Takashi Kageyama, Osaka-shi (JP); Shinji Ishikawa, Tokyo (JP)

(73) Assignees: TSUBAKIMOTO CHAIN CO., Osaka (JP); TOAN CO., LTD., Tokyo (JP)

(21) Appl. No.: 15/956,872

(22) Filed: Apr. 19, 2018

Related U.S. Application Data
(63) Continuation of application No. PCT/JP2016/071243, filed on Jul. 20, 2016.

(30) Foreign Application Priority Data
Oct. 29, 2015 (JP) 2015-212499

(51) Int. Cl. B61B 13/02; B65G 35/08; F16H 19/04; B62D 65/18; B65G 35/06

(52) U.S. Cl. CPC B61B 13/02; B65G 35/08; B65G 35/06; B62D 65/18; F16H 19/04

(57) ABSTRACT

To provide a conveyance system and a rack made up of simple mechanical structures only and free of malfunctions, the rack being capable of reliably meshing with and separating from a plurality of pinions one after another without stoppage or breakage with less impact, vibration, noise and the like even when there are differences in phases and speeds. A rack (120) includes a main body (121) provided with a plurality of fixed rack teeth (122) in a central part thereof, and a movable part (123) provided with movable rack teeth (124) continuous with at least one end of the fixed rack teeth (122). The movable part (123) is pivotally supported around a support shaft (125). The support shaft (125) is provided more forward in a moving direction than a position where the movable rack teeth (124) of the movable part (123) are located.

### TECHNICAL FIELD

The present invention relates to a conveyance system that transfers moving members such as carriages by rotation of pinions meshed with racks provided to the moving members such as carriages.

### BACKGROUND ART

Various designs are known for conveyance systems in which moving members such as carriages are transferred; in some systems, drive units are provided in moving members for movement or on transport paths, and in other systems, a plurality of moving members are coupled together and towed, or brought into and out of engagement with running chains or the like.

In a known conveyance system used for applying a coating on car bodies or the like, for example, wherein car bodies or the like are transported from one to another of various steps such as coating and drying while being held on carriages that are moving members, racks are provided to the carriages, while pinions are disposed along the transport path, so that the carriages are moved by rotation of the pinions meshing with the racks on the carriages (see, for example, Patent Literature 1).

In such a conveyance system in which rack and pinion engagement is adopted, a plurality of pinions are disposed on the transport path and the racks on the carriages are carried toward a predetermined direction as the racks come into and out of engagement with the plurality of pinions one after another. Any phase or speed difference between the rack teeth and pinion teeth at the time of contact would pose a risk of dust generation along with the impact, vibration, and noise generation. In the worst scenario the rack or pinion could break, or fail to engage and stop.

When the conveyance system is used to baking and drying process steps or the like, in particular, the problem of a phase difference is inevitably involved because, even though the rack teeth and pinion teeth are in the correct phase relationship with each other when the pinions are installed, the high temperature oven itself undergoes expansion and contraction under large temperature changes, which causes the pitches of the built-in pinions to increase and decrease.

The problem noted above was even more likely to happen when the total length of the rack was large or the rack teeth had a small pitch because the influence of a phase difference caused by temperature changes on the rack teeth and pinion teeth would be larger.

A known conveyance system deals with this problem by detecting positions of the racks and rotational phases of the pinions and to exercise control so that the phases and speeds of the rack teeth and pinion teeth will match (see, for example, Patent Literature 2).

In another known conveyance system, a front end portion of the rack including a first tooth that comes to mesh with the pinion first is formed as a movable part (separate component), and pivotally supported by a support shaft that is parallel to the rotation axis of the pinion. This support shaft is positioned more rearward than the first tooth, to cause the movable part (separate component) to pivot and to press the first tooth against the pinion (see, for example, Patent Literature 3).

### CITATION LIST

### Patent Literature

Patent Literature 1: Japanese Patent Application Laid-open No. 2007-276515

Patent Literature 2: Japanese Patent Application Laid-open No. 2005-206051

Patent Literature 3: Japanese Patent Application Laid-open No. 2006-038190

### SUMMARY OF INVENTION

### Technical Problem

According to the conveyance system known from Patent Literature 2, the impact of contact between the rack and pinion can be reduced if their phases and speeds are matched when the rack comes into mesh with the pinion in front.

However, the system would be complex and require frequent maintenance to prevent malfunctions because of the need to provide electrical detection and control mechanisms on the transport paths.

Such a system could hardly be adopted for transportation of whole carriages from one to another of process steps such as coating and drying because the conveyance system would be installed in an environment with paint spray and under high temperatures.

According to the conveyance system known from Patent Literature 3, when there is a phase difference between the rack teeth and the pinion teeth in the front, the pinion teeth push up the movable part (separate component) at the front end of the rack as the rack comes into mesh with the pinion in the front. The movable part (separate component) pivots around the support shaft so that the impact is mitigated. When the pinion teeth at the back and the rack teeth go out of mesh, the rack moves slightly toward the direction in which the phases will match, so that the movable part (separate component) returns to the original position and the rack teeth and pinion teeth mesh each other.

This conveyance system known from Patent Literature 3 is made up of mechanical structures only, so that it can be installed in an environment with paint spray and under high temperatures.

However, since the pivot center of the movable part (separate component) is positioned more rearward in the moving direction than the rack tooth that comes to mesh with the pinion teeth first, when the moving speed of the rack is faster than the circumferential speed of the pinion, the rack may be subjected to a large pressing force in the moving direction at the time of contact with the pinion depending on the point of contact between the pinion teeth and rack teeth. A large frictional force thus produced may cause a large impact when the movable part (separate component) is pushed up against the frictional force, and there is even a possibility that the frictional force is too large for the movable part to be pushed up so that the rack may stop or break.

Moreover, if, after the pinion teeth have pushed up the movable part (separate component) at the front end of the rack, it took time for the rack and pinion to be back in the correct phase relationship, the pinion teeth would push up the movable part (separate component) further at a point closer to the pivot center. The movable part (separate component) may then contact the structure above and generate a large impact, or the rack may stop or break if the movable part cannot be pushed up further.

Therefore, the speeds of adjacent pinions had to be synchronized when the conveying speed is to be changed.

The present invention solves these problems, and it is an object of the invention to provide a conveyance system and a rack made up of simple mechanical structures only and free of malfunctions, the rack being capable of reliably meshing with and separating from a plurality of pinions one after another without stoppage or breakage with less impact, vibration, noise and the like even when there are differences in phases and speeds of adjacent pinions, or even when there is a phase difference in the pinions due to temperature changes.

### Solution to Problem

The present invention solves the problems described above by providing a conveyance system including: a rack provided to a moving member, and a pinion meshed with the rack to move the moving member, the rack including a main body provided with a plurality of fixed rack teeth in a central part thereof, and a movable part provided with movable rack teeth continuous with at least one end of the fixed rack teeth, the movable part being pivotally supported around a support shaft, the support shaft and the movable part being provided at each of both ends on front and rear sides of the main body in a moving direction, the support shafts on the front and rear sides both being provided more forward in the moving direction than positions where the movable rack teeth of the movable parts are located.

The present invention solves the problems described above by providing a rack that is meshed with a pinion and moved by rotation of the pinion, the rack including a main body provided with a plurality of fixed rack teeth in a central part thereof, and a movable part provided with movable rack teeth continuous with at least one end of the fixed rack teeth, the movable part being pivotally supported around a support shaft, the support shaft and the movable part being provided at each of both ends on front and rear sides of the main body in a moving direction, the support shafts on the front and rear sides both being provided more forward in the moving direction than positions where the movable rack teeth of the movable parts are located.

### Advantageous Effects of Invention

According to the conveyance system as set forth in claim 1 and the rack as set forth in claim 3, the support shaft is provided more forward in a moving direction than a position where the movable rack teeth of the movable part are located. The movable part is readily pushed up by contact between the pinion and the rack tooth that comes to mesh with the pinion teeth first even when the phases and speeds of the rack teeth and pinion teeth are different from each other. The movable part is readily and not forcefully pushed up and receives no large pressing force in the moving direction even when the moving speed of the rack teeth is faster than the circumferential speed of the pinion.

After the movable part has been pushed up, it may take time for the rack teeth and pinion teeth to be back in the correct phase relationship. Even so, the rack teeth are pushed up one after another away from the support shaft, so that the amount of pushing up the movable part is gradually reduced.

As a result of these, the rack, which is made up of simple mechanical structures only, is free of malfunctions, and can reliably come into and out of engagement with a plurality of pinions one after another without stoppage or breakage with less impact, vibration, noise and the like, even when there are differences in phase and speed of the rack teeth and pinion teeth, or even when there is a phase difference in the pinions due to temperature changes.

The moving speed of the rack can be set differently for each transport section merely by setting the speeds of the pinions independently for each transport section. There is no need to synchronize adjacent pinions, so that a complex control mechanism is not necessary.

Moreover, the support shaft and the movable part are provided at both ends on both front and rear sides of the main body in the moving direction, and the support shafts on the front and rear sides are both provided more forward in the moving direction than a position where the movable rack teeth of the movable part are located. Therefore, when the circumferential speed of the front side pinion is faster than that of the rear side pinion, the movable part provided at the back is pushed up as the rack meshes with the front side pinion and the speed is increased. Thus the rack can reliably come into and out of engagement with the plurality of pinions one after another.

According to the configuration as set forth in claim 2, teeth of the movable part that are closer to the support shaft are formed to have low tops. This makes the pivoting angle smaller when the movable part is pushed up by contact between the pinion and the rack tooth that comes to mesh with the pinion teeth first. Therefore, the clearance above the movable part can be made smaller.

### BRIEF DESCRIPTION OF DRAWINGS

FIG. 1 is a side view of a conveyance system according to one embodiment of the present invention.

FIG. 2 is a front view of the conveyance system according to one embodiment of the present invention.

FIG. 3 is a plan view of part of the conveyance system according to one embodiment of the present invention.

FIG. 4 is a side view of a rack and a pinion according to one embodiment of the present invention.

FIG. 5 is a side view of the rack and pinion in a section where the speeds of the front and rear pinions are different.

FIG. 6 is a side view of the rack and pinion in a section where the speed is changed continuously.

### REFERENCE SIGNS LIST

100 Conveyance system
101 Rail
102 Car body (transported object)
110 Carriage (moving member)
111 Wheel
112 Vehicle body support table
120 Rack
121 Main body
122 Fixed rack teeth
123 Movable part
124 Movable rack teeth
125 Support shaft
126 Movable part cover
130 Pinion
131 Pinion teeth
132 Rotary shaft

### DESCRIPTION OF EMBODIMENT

### Embodiment 1

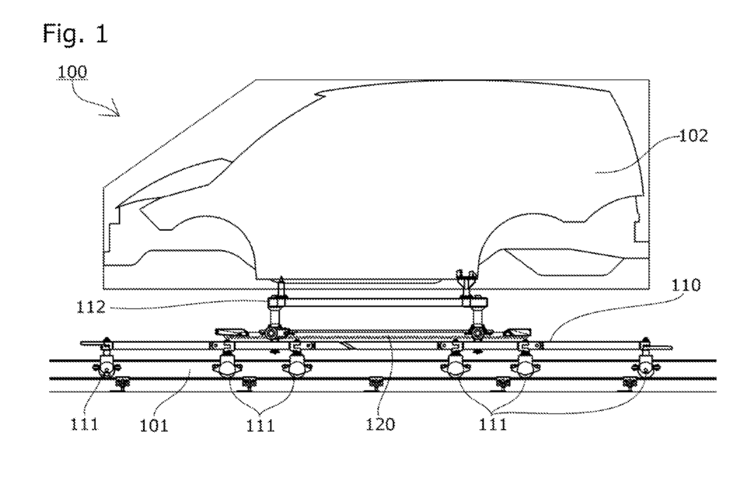

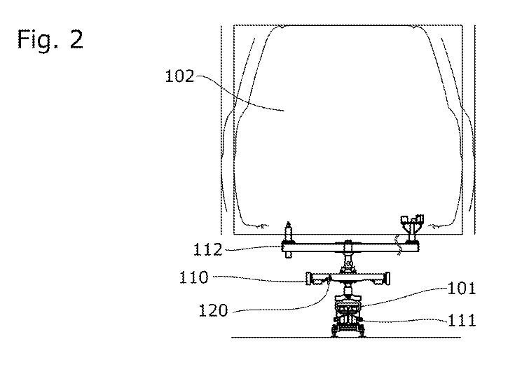

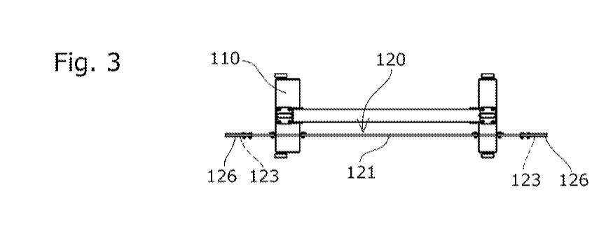

A conveyance system 100 according to one embodiment of the present invention is configured such that, as shown in FIG. 1 to FIG. 3, a carriage 110, which is a moving member, carries a car body 102, which is a transported object, on a vehicle body support table 112 above the carriage. Wheels 111 are provided to the carriage for running on a rail 101.

A rack 120 extending along a moving direction is fixed to the carriage 110. The system is configured such that the rack meshes with pinions (not shown) spaced apart a predetermined distance on one side of the rail 101 and the pinions are rotated to move the meshing rack 120 in the moving direction so that the carriage 110 moves.

The carriage and rail, and the support of the transported object can be structured in any way. For example, the rail may be provided above and the transported object may be hung from the carriage.

The running mechanism of the carriage can be configured in any way. The carriage may run on rollers or the like set on the rail, run by magnetic levitation or air levitation, or slide on a low-friction surface.

The transported object can be anything.

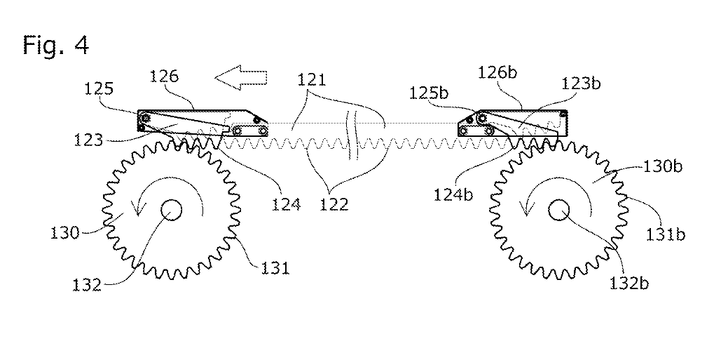

The rack 120 includes, as shown in FIG. 4 to FIG. 6, a main body 121 that has a plurality of fixed rack teeth 122 in a central part thereof, a movable part 123 provided with movable rack teeth 124 continuous with an end portion on the front side of the moving direction of the fixed rack teeth 122 (hereinafter simply referred to as “front side”), and a movable part 123b provided with movable rack teeth 124b continuous with an end portion on the rear side of the moving direction of the fixed rack teeth 122 (hereinafter simply referred to as “rear side”).

Movable part covers 126 and 126b that double as stoppers for restricting the movable parts 123 and 123b from springing up too much are fixedly provided to the main body 121 above the movable parts 123 and 123b, respectively.

The movable part 123 on the front side is pivotally supported around a support shaft 125 provided at one end on the front side of the movable part cover 126, while the movable part 123b on the rear side is pivotally supported around a support shaft 125b provided on one side of the movable part cover 126b closer to the main body 121. Both support shafts 125 and 125b are positioned more forward than the positions where the movable rack teeth 124 and 124b of the movable parts 123 and 123b are located.

The movable rack teeth 124 of the movable part 123 on the front side that are closer to the support shaft 125 are formed to have low tops.

The operation of the conveyance system 100 of this embodiment configured as described above will be explained.

In a section where the carriage 110 is transported at constant speed, the distance between the rotary shafts 132 and 132b of a front side pinion 130 and a rear side pinion 130b is set substantially equal to the distance between the top of the foremost one of the movable rack teeth 124 of the front side movable part 123 and the top of the rearmost one of the movable rack teeth 124b of the rear side movable part 123b as shown in FIG. 4.

Therefore, when the foremost movable rack tooth 124 of the front side movable part 123 is out of phase with the pinion teeth 131 of the front side pinion 130, the impact at the time of first contact is mitigated as the front side movable part 123 is pushed up.

After that, immediately after the rearmost movable rack tooth 124b of the rear side movable part 123b comes out of engagement with the pinion teeth 131b of the rear side pinion 130b, the movable rack teeth 124 of the front side movable part 123 are positioned where they can mate with the pinion teeth 131 of the front side pinion 130. The rack 120 is slightly shifted in the front to back direction, which causes the front side movable part 123 to pivot down and smoothly mate with the continuous fixed rack teeth 122.

Since the movable part cover 126 that doubles as the stopper for restricting the movable part 123 from springing up too much is provided above the movable part 123, the movable part 123 is prevented from colliding the upper structure of the carriage 110 or various structures along the conveyance line.

The movable rack teeth 124, closer to the support shaft 125, of the front side movable part 123 that first come to contact with the pinion teeth 131 of the front side pinion 130 are formed to have low tops. Therefore, the amount of pushing up the rack teeth when they are out of phase can be made small, and the height of the movable part cover 126 can be made small, which reduces the limitations imposed by the upper structure of the carriage 110 or various structures along the conveyance line on the mounting position of the rack 120 to the carriage 110 or on the length of the rack 120.

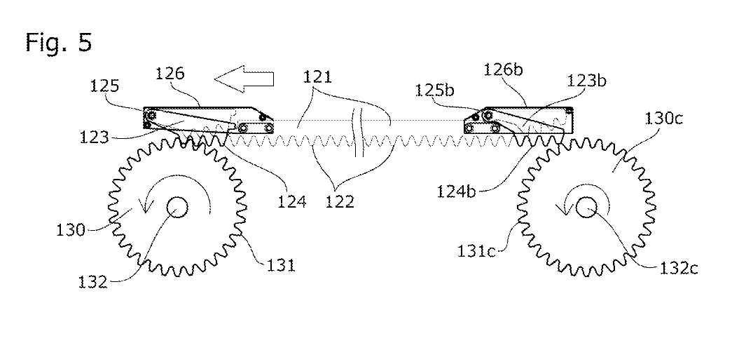

When the speed of the carriage 110 is to be changed, the front side pinion 130 and rear side pinion 130c are driven at different constant speeds as shown in FIG. 5.

The speed is reduced in the following manner: the movable rack teeth 124 of the front side movable part 123 come into contact with the pinion teeth 131 of the front side pinion 130 while moving faster than the pinion teeth 131. Therefore, while the speed of the carriage 110 is maintained, the front side movable part 123 is pushed up, without the movable rack teeth 124 and the pinion teeth 131 meshing each other.

After the pinion teeth 131c of the rear side pinion 130c and the rearmost movable rack tooth 124b of the rear side movable part 123b have disengaged from each other, the carriage 110 slows down, so that the speed and phase of the movable rack teeth 124 of the front side movable part 123 match with those of the pinion teeth 131 of the front side pinion 130. The front side movable part 123 then pivots downward and mates with the pinion teeth correctly.

As shown in FIG. 5, the distance between the rotary shafts 132 and 132c of the front side pinion 130 and the rear side pinion 130c is set wider than the distance between the top of the foremost movable rack tooth 124 of the front side movable part 123 and the top of the rearmost movable rack tooth 124b of the rear side movable part 123b, to ensure ample time before the speed and phase of the movable rack teeth 124 of the front side movable part 123 match with those of the pinion teeth of the front side pinion 130 when the carriage 110 slows down. This way, a larger speed change can be achieved smoothly.

The speed is increased in the following manner: the movable rack teeth 124 of the front side movable part 123 come into contact with the pinion teeth 131 of the front side pinion 130 while moving more slowly than the pinion teeth 131. Therefore, depending on the timing, the movable rack teeth 124 and the pinion teeth 131 may mate with each other at an earlier stage, whereupon the carriage 110 may speed up.

Even if the rearmost movable rack tooth 124b of the rear side movable part 123b and the pinion teeth 131c of the rear side pinion 130c are in mesh with each other when the speed of the carriage 110 is increased, the rear side movable part 123b is pushed up and disengaged, because the rear side movable part 123b is pivotally supported around the support shaft 125b provided on the rear side movable part cover 126b on the side closer to the main body 121, and because the support shaft 125b is positioned more forward than the position where the movable rack teeth 124b of the rear side movable part 123b are located. Thus a smooth speed change of the carriage 110 is achieved.

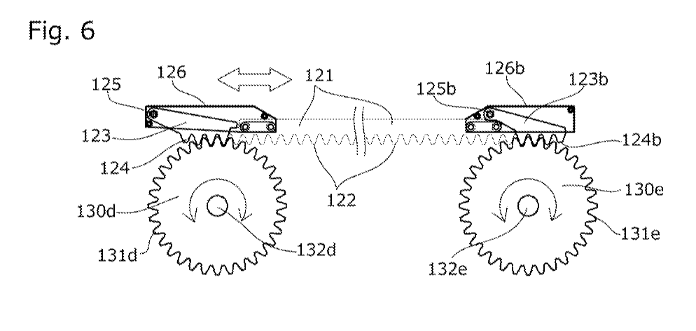

In a section where not only the speed of the carriage 110 is changed continuously but also the conveying direction is temporarily reversed, the distance between the front side pinion 130d and the rear side pinion 130e is set such that the front side pinion teeth 131d come to contact with the fixed rack teeth 122 at the front end of the main body 121 of the rack 120 before the rear side pinion teeth 131e separate from the fixed rack teeth 122 at the rear end of the main body 121 of the rack 120, as shown in FIG. 6.

Such a section requires precise control of the speed, conveying direction, position or the like of the carriage 110, and therefore the speeds and phases of the front side pinion 130d and rear side pinion 130e are controlled precisely. Therefore, the movable rack teeth 124 and 124b of the movable parts 123 and 123b at both ends need not operate. One of the pinion teeth 131d and 131e is always in engagement with and drives the fixed rack teeth 122, so that the speed, conveying direction, position or the like can be controlled precisely without being affected by speed changes or position misalignment involved in the pivoting movement of the movable parts 123 and 123b.

While one embodiment of the present invention has been described in detail above, the present invention is not limited to the embodiment described above, and various design changes can be made without departing from the scope of the present invention set forth in the claims.

For example, while the pinion 130 mates with the rack 120 from below and the movable part 123 or 123b that is pushed up returns to its original position by gravity in the embodiment described above, a biasing member such as a spring may be provided to increase the force in the returning direction, or, conversely, the movable part may be biased to reduce the force to push it up.

The pinions may engage with the rack from one side or from above in accordance with the form of the carriage. In this case, some type of biasing member would be needed for the movable part to return to its original position.

Another drive unit may be provided in addition to the rack and pinion system, and the drive units may be switched in accordance with the conveyance type as required.

The rack teeth and pinion teeth may have any shapes as long as they can mate with each other to transmit power. A drive unit known as “pin gear” system wherein sprockets are used instead of pinions, and the rack has equally spaced pins, can also be used.

1. A conveyance system comprising: a rack provided to a moving member; and a pinion meshed with the rack to move the moving member,
the rack including a main body provided with a plurality of fixed rack teeth in a central part thereof, and a movable part provided with movable rack teeth continuous with at least one end of the fixed rack teeth,
the movable part being pivotally supported around a support shaft,
the support shaft and the movable part being provided at each of both ends on front and rear sides of the main body in a moving direction,
the support shafts on the front and rear sides both being provided more forward in the moving direction than positions where the movable rack teeth of the movable parts are located.

2. The conveyance system according to claim 1, wherein teeth of the movable part that are closer to the support shaft are formed to have low tops.

3. A rack that is meshed with a pinion and moved by rotation of the pinion, the rack comprising:
a main body provided with a plurality of fixed rack teeth in a central part thereof, and a movable part provided with movable rack teeth continuous with at least one end of the fixed rack teeth,
the movable part being pivotally supported around a support shaft,
the support shaft and the movable part being provided at each of both ends on front and rear sides of the main body in a moving direction,
the support shafts on the front and rear sides both being provided more forward in the moving direction than positions where the movable rack teeth of the movable parts are located.
